(19) United States
(12) Patent Application Publication
(10) Pub. No.: US 2024/0367545 A1
(43) Pub. Date: Nov. 7, 2024

(54) BATTERY SWAPPING SYSTEM FOR ELECTRIC VEHICLE, ELECTRIC VEHICLE, AND BATTERY SWAPPING METHOD FOR ELECTRIC VEHICLE

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); Chunhua Huang, Shanghai (CN)

(21) Appl. No.: 18/575,826

(22) PCT Filed: Nov. 30, 2022
(86) PCT No.: PCT/CN2022/135440

§ 371 Date: Dec. 30, 2023

(30) Foreign Application Priority Data
Nov. 30, 2021 (CN) 202111444383.8
Dec. 26, 2021 (CN) 202111606763.7
Dec. 26, 2021 (CN) 202111606781.5
Dec. 31, 2021 (CN) 202111673991.6

(51) Int. Cl. B60L 53/80; B60K 1/04; H01M 50/249; H01M 50/264

(52) U.S. Cl. CPC B60L 53/80; B60K 1/04; H01M 50/249; H01M 50/264; B60K 2001/0455

(57) ABSTRACT

The invention discloses a battery swapping system for an electric vehicle, an electric vehicle and a battery swapping method for an electric vehicle, and the electric vehicle comprises two longitudinal beams, the battery swapping system comprises a battery pack and a plurality of locking mechanisms, and the plurality of locking mechanisms are respectively arranged on the two longitudinal beams, and the top of the battery pack is provided with a groove, and the groove is used for embedding the longitudinal beam, and the battery pack is provided with a plurality of locking members, and the plurality of locking members are located in the groove, and the battery pack is connected with the longitudinal beams by the plurality of locking members locked in the plurality of locking mechanisms.

The present application claims the priority of Chinese patent application CN2021116739916 filed on Dec. 31, 2021, the priority of Chinese patent application CN2021116067637 filed on Dec. 26, 2021, the priority of Chinese patent application CN2021116067815 filed on Dec. 26, 2021, and the priority of Chinese patent application CN2021114443838 filed on Nov. 30, 2021. The contents of the above Chinese patent applications are incorporated herein by reference in their entireties.

### TECHNICAL FIELD

The invention relates to the technical field of chassis battery swapping, in particular to a battery swapping system of an electric vehicle, an electric vehicle and a battery swapping method of an electric vehicle.

### BACKGROUND

In recent years, new energy vehicles are developing rapidly, electric vehicles relying on batteries as the driving energy have the advantages of zero emission and low noise, and with the increasing market share and use frequency of electric vehicles, electric commercial vehicles, such as electric heavy trucks and electric light trucks, are gradually widely used, and battery swapping technology is also gradually applied to the field of commercial vehicles.

At present, battery packs on electric trucks are generally installed above the longitudinal beam of the vehicle body, and direct-swapping battery packs or quick-swapping battery packs are mounted above the longitudinal beam, and the longitudinal beam is used to support the battery packs. Because the position of the longitudinal beam in the electric truck is relatively high to the ground and the weight of the battery pack is heavy, the center of gravity of the battery pack is relatively high and the stability of the vehicle is relatively poor, which affects the driving safety of the vehicle and occupies a large space behind the driver and the driver has a poor driving experience. In addition, because the battery pack is arranged above the longitudinal beam, the battery pack can only be swapped by the hoisting structure, and the construction of the battery swapping station which adopts the hoisting structure has large height and large floor area, high maintenance cost and poor safety.

### CONTENT OF THE PRESENT INVENTION

The technical problem to be solved by the invention is in order to overcome the defects in the prior art such as the relatively high center of gravity of the battery pack, the poor stability of the battery pack relative to the vehicle, large space occupied behind the driver, and poor driving experience of the driver, providing a battery swapping system of an electric vehicle, an electric vehicle and a battery swapping method of an electric vehicle.

The present invention solves the above-mentioned technical problems through the following technical solutions:

A battery swapping system of an electric vehicle, the electric vehicle comprising two longitudinal beams: the battery swapping device comprises a battery pack and a plurality of locking mechanisms; and the plurality of the locking mechanisms are respectively arranged on the two longitudinal beams, and the top of the battery pack is provided with a groove, and the groove is used for embedding the longitudinal beam, and the battery pack is provided with a plurality of locking members, and the plurality of locking members are located in the groove, and the battery pack is locked in the plurality of locking mechanisms by means of a plurality of locking members so as to be connected with the longitudinal beams.

In this solution, the above-mentioned structural form is adopted to realize chassis battery swapping using the two longitudinal beams of the electric vehicle, and to realize the center of gravity of the battery pack is located below the longitudinal beams, which effectively lowers the center of gravity of the battery pack and increases the stability of the battery pack, and the stability and safety are improved by a great step: the locking member is arranged in the groove on the top of the battery pack and makes the connection between the battery pack and the longitudinal beam more stable. At the same time, the structure is compact and the utilization rate of the space especially the space in the vertical direction is high.

Preferably, the plurality of locking mechanisms are respectively arranged on the side walls of the two longitudinal beams and/or the bottom of the two longitudinal beams.

In this solution, the above-mentioned structural form is adopted to realize a variety of mounting and arranging forms of the locking mechanism, and the position can be arranged discretionarily according to the space, and the connection is more stable.

Preferably, the battery pack comprises a plurality of battery cell accommodating cavities for placing battery cells, and at least part of the battery cell accommodating cavities are distributed on the side part of the longitudinal beam.

In this solution, the above-mentioned structure form is adopted so that the battery cells in the battery pack are accommodated and placed along the width direction of the electric vehicle to realize more battery cells being accommodated in the battery pack, longer distance of travel of the electric vehicle and less frequency of swapping battery packs; and at the same time, the space utilization rate is higher.

Preferably, a plurality of battery cell accommodating cavities comprise a plurality of side battery cell accommodating cavities, and the plurality of side battery cell accommodating cavities are distributed on two opposite sides of the two longitudinal beams.

In this solution, the above-mentioned structure form is adopted so that the battery cells placed in the plurality of side battery cell accommodating cavities are distributed on two opposite sides of the two longitudinal beams to achieve higher space utilization rate and increase the battery cell capacity of the battery pack.

Preferably, a plurality of cross beams are connected between the two longitudinal beams, and the plurality of battery cell accommodating cavities further comprise a middle battery cell accommodating cavity, the plurality of side battery cell accommodating cavities being distributed on both sides of the middle battery cell accommodating cavity, and the middle battery cell accommodating cavity is located below the cross beams.

In this solution, the above-mentioned structure form is adopted to effectively enhance the overall structural strength by means of connecting a plurality of cross beams between the two longitudinal beams, and therefore the safety and stability of the electric vehicle are improved. At the same time, the middle battery cell accommodating cavity is used for placing the battery cells, so that the space between the longitudinal beams of the electric vehicle is further fully utilized, and the battery cells can be respectively mounted on both sides and the middle of the longitudinal beams to achieve higher space utilization rate and further increase the battery cell capacity of the battery pack.

Preferably, the battery swapping system further comprises a fixing bracket, the fixing bracket being arranged on the side walls of the longitudinal beam or at the bottom of the longitudinal beam, and the plurality of locking mechanisms are arranged on the fixing bracket.

In this solution, the above-mentioned structure form is adopted to be convenient to mount the plurality of locking mechanisms and to promote installation accuracy: at the same time, the strength and stability of the battery swapping system are improved.

Preferably, the fixing bracket comprises two mounting beams, one side of the two mounting beams being respectively connected to the opposite sides of the two longitudinal beams, and the plurality of locking mechanisms are respectively connected to the other side of the two mounting beams.

In this solution, the above-mentioned structure form is adopted to mount a plurality of locking mechanisms, and the installation accuracy is high; and at the same time, the strength and stability of the battery swapping system are improved.

Preferably, the battery swapping system further comprises a reinforcement member for mounting the electrical connector, the reinforcement member being located between the two longitudinal beams and the two ends of the reinforcement member are respectively connected to the two longitudinal beams.

In this solution, the above-mentioned structure form is adopted to be convenient for the installation of the electrical connector, and the reinforcement member performs a strengthening function, and the overall structural strength of the electric vehicle is effectively improved by means of connecting the reinforcement member to the two longitudinal beams and the safety and stability of the electric vehicle are improved.

Preferably, the reinforcement member comprises a connecting member and a mounting plate, the connecting member is respectively connected to the two longitudinal beams and the mounting plate, and the mounting plate is used for mounting the electrical connector.

In this solution, the above-mentioned structure form is adopted that by the connecting member connecting to the two longitudinal beams, the connecting strength of the structure is enhanced. The electrical connector is mounted on the mounting plate, and the mounting of the electrical connector is convenient through the mounting plate.

Preferably, the reinforcement member further comprises two reinforcement plates, the two reinforcement plates being respectively connected to the two longitudinal beams, and the reinforcement plates are connected to the connecting member and the mounting plate.

In this solution, the above-mentioned structure form is adopted so that the two reinforcement plates perform the reinforcing function, which effectively enhances the structural connection strength, and the safety and stability of the electric vehicle are improved.

Preferably, the locking mechanism comprises a locking groove for the locking member to insert into, the opening of the locking groove faces the outer side of the longitudinal beam.

In this solution, the above-mentioned structure form is adopted so that the locking member can be conveniently inserted into the locking groove, and the structure of the locking groove is simple and convenient for machining and manufacturing.

Preferably, the locking mechanism comprises a locking base, the locking base being provided with an opening groove extending in the vertical direction and a locking groove extending in the horizontal direction, the locking member being a locking shaft, and the locking groove is used for the locking shaft to insert into and be locked, and the top of the opening groove is communicated with the locking groove, and when the locking shaft reaches the junction position of the opening groove and the locking groove from the bottom of the opening groove in the vertical direction, the locking shaft enters the locking groove.

In this solution, the above-mentioned structure form is adopted so that the locking and unlocking are realized by means of the displacement of the battery pack along the vertical direction and the horizontal direction, and the installation and disassembly are very convenient, and the structure is simple and the processing and manufacture are convenient.

Preferably, at least part of the locking bases are provided with a locking tongue, and the locking tongue is movably mounted in the locking groove and can prevent the locking shaft from getting out of the locking groove.

In this solution, the above-mentioned structure form is adopted so that the locking member is stably inserted into the locking groove by means of the locking tongue, and the locking is more reliable, and thereby the stability of the locking mechanism in the locking state is improved.

Preferably, the locking mechanism further comprises a locking linkage, the locking linkage being movably connected with the locking base by means of the locking tongue.

In this solution, the above-mentioned structure form is adopted so that the locking linkage drives the locking tongue under external force to close or open the locking groove and the locking is more reliable; and at the same time, the synchronous unlocking or locking of the plurality of locking tongues can be realized through the locking linkage, which is very convenient to use and reduces the cost.

Preferably, the locking mechanism comprises a locking base, the locking base being provided with an opening extending along the vertical direction, the opening is provided with a first thread part or a limiting part, and the locking member is provided with a matched second thread part or a stopping part.

In this solution, the above-mentioned locking structure form is adopted so that the locking is realized between the locking base and the locking member only in the vertical direction, which realizes a variety of mounting and connection forms and more stable connection and high utilization rate of the structure space.

Preferably, the battery swapping system further comprises a plurality of guiding and positioning mechanisms, and the plurality of guiding and positioning mechanisms are arranged on the longitudinal beam or the battery pack so as to realize the precise positioning of the battery pack on the longitudinal beam.

In this solution, the above-mentioned structure form is adopted so that the guiding and positioning mechanism performs the guiding and positioning function, and the battery pack can be positioned right by the guiding and positioning acting force of the guiding and positioning mechanism, so as to realize precise positioning, and the installation and disassembly of the battery pack are more stable.

Preferably, the guiding and positioning mechanism is an elastic positioning mechanism.

In this solution, the elastic positioning mechanism will provide clamping force to the longitudinal beam to effectively prevent the battery pack from producing large deviation and dislocation during use, and thus the safety and stability are improved.

An electric vehicle, which is a heavy truck or a light truck, and the electric vehicle comprises the above-described battery swapping system of the electric vehicle.

In this solution, the above-mentioned structure form is adopted so that it is realized that swap battery using the chassis of the two longitudinal beams of the electric vehicle, and that the center of gravity of the battery pack is located below the longitudinal beams, which greatly improves the stability and safety of the vehicle; and at the same time, the structure is compact and the space utilization is high.

A battery swapping method of an electric vehicle, adopting the above-described battery swapping system of the electric vehicle, and the battery swapping method comprises the following steps:

Control the battery swapping device to move the battery pack to the battery swapping position below the longitudinal beam, so that the groove on the top of the battery pack is aligned with the longitudinal beam:

Control the battery swapping device to lift the battery pack to a preset height, and make the locking member on the battery pack enters the locking mechanism on the longitudinal beam, and make the groove on the top of the battery pack covers the longitudinal beam:

Control the locking member to lock and connect in place with the locking mechanism.

In this solution, the accurate control is realized, and the safety and stability are high. At the same time, it is realized that swap battery using the chassis of the two longitudinal beams of the electric vehicle, which reduces the risk of failure during battery swapping and improves the safety, and the chassis battery swapping system occupies a small floor area and the popularization cost of the battery swapping station is low.

Preferably, the step of controlling the battery swapping device to lift the battery pack to a preset height further comprises an initial positioning step;

The initial positioning step comprises controlling the battery swapping device to lift the battery pack, the plurality of initial positioning mechanisms on the inner wall of the groove carrying out initial positioning and guiding for the battery pack so that the opening of the groove is aligned with the longitudinal beam, and the longitudinal beam enters the opening of the groove.

In this solution, a plurality of initial positioning mechanisms carry out initial positioning and guiding for the battery pack, which is convenient for the longitudinal beam to accurately align with the groove and smoothly enters the groove, and thus the safety and stability are improved.

Preferably, the step of controlling the battery swapping device to lift the battery pack to a preset height further comprises a precise positioning step, and the precise positioning step is after the initial positioning step;

The precise positioning step comprises controlling the battery swapping device to continue lifting the battery pack, and the plurality of precise positioning mechanisms on the inner wall of the groove carrying out precise positioning and guiding for the battery pack so that the groove covers the longitudinal beam to a preset position, making the locking member of the battery pack enter the locking mechanism on the longitudinal beam.

In this solution, the battery pack is precisely positioned and guided by a plurality of precise positioning mechanisms, and the locking accuracy is higher; and at the same time, the deviation and dislocation phenomenon of the battery pack is effectively avoided during use, which greatly improves safety and stability.

Preferably, the plurality of initial positioning mechanisms and the plurality of precise positioning mechanisms abut against the longitudinal beam and limit the displacement of the longitudinal beam in the groove.

In this solution, the inclined displacement of the longitudinal beam in the horizontal direction is therefore effectively limited, and the safety and stability are higher.

On the basis of conforming to the common sense in the art, the above-mentioned preferred conditions can be arbitrarily combined to obtain the preferred examples of the invention.

The positive progressive effect of the invention is that:

The battery swapping system of an electric vehicle realizes the chassis battery swapping by adopting the two longitudinal beams of the electric vehicle, and the battery pack is connected with the locking structure on the two longitudinal beams by means of the locking member in the groove on the top of the battery pack, so that the connection between the battery pack and the longitudinal beam is more stable, and the center of gravity of the battery pack is below the longitudinal beam, which effectively lowers the center of gravity of the battery pack and increases the stability of the battery pack, and the stability and safety are greatly improved; and at the same time, the structure is compact and the utilization rate of the space especially the space in the vertical direction is high. In addition, through chassis battery swapping, the failure risk during battery swapping is lowered and safety is improved, and the floor area of the chassis battery swapping system is small, and the popularization cost of the battery swapping station is low.

### BRIEF DESCRIPTION OF THE DRAWINGS

FIG. 1 is a structural schematic diagram of an electric vehicle according to an embodiment of the present invention.

FIG. 2 is an exploded structural schematic diagram of an electric vehicle according to an embodiment of the present invention.

FIG. 3 is an exploded structural schematic diagram of the battery swapping system and two longitudinal beams according to an embodiment of the present invention.

FIG. 4 is a structural schematic diagram of two longitudinal beams and a locking mechanism according to an embodiment of the present invention.

FIG. 5 is a structural schematic diagram of the two longitudinal beams and the locking mechanism in another view according to an embodiment of the present invention.

FIG. 6 is a structural schematic diagram of the locking mechanism according to an embodiment of the present invention.

FIG. 7 is a structural schematic diagram of the battery swapping system before installation according to an embodiment of the present invention.

FIG. 8 is a structural schematic diagram of the battery swapping system in the initial positioning according to an embodiment of the present invention.

FIG. 9 is a structural schematic diagram of the battery swapping system in the precise positioning according to the embodiment of the present invention.

FIG. 10 is a structural schematic diagram of the battery swapping system after the installation is completed according to an embodiment of the present invention.

FIG. 11 is a flowchart of the battery swapping method of an electric vehicle according to an embodiment of the present invention.

FIG. 12 is a flowchart of controlling the battery swapping device to lift the battery pack to a preset height according to an embodiment of the present invention.

### DESCRIPTION OF REFERENCE NUMERALS

Battery pack 1; groove 11; locking member 12; side battery cell accommodating cavity 13; middle battery cell accommodating cavity 14; locking mechanism 2; locking base 21; locking tongue 22; locking linkage 23; battery cell 3; mounting beam 4; reinforcement member 5; mounting plate 51; connecting member 52; reinforcement plate 53; electrical connector 6; initial positioning mechanism 7; precise positioning mechanism 8; longitudinal beam 10.

### DETAILED DESCRIPTION OF THE PREFERRED EMBODIMENT

The present invention is explained more clearly through embodiments and in conjunction with the accompanying drawings, but it is not therefore limited to the scope of the embodiments

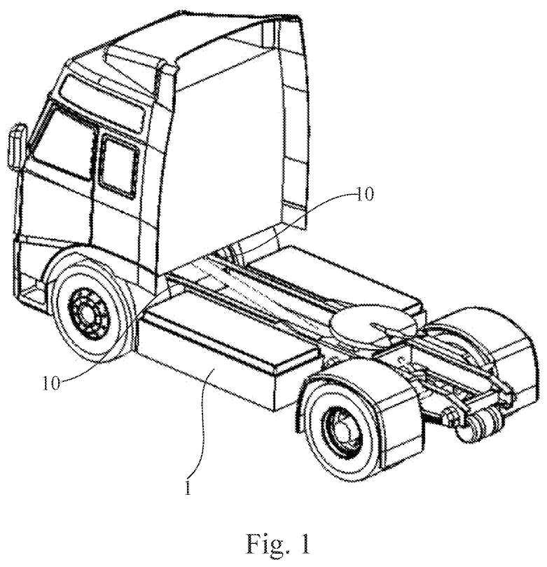

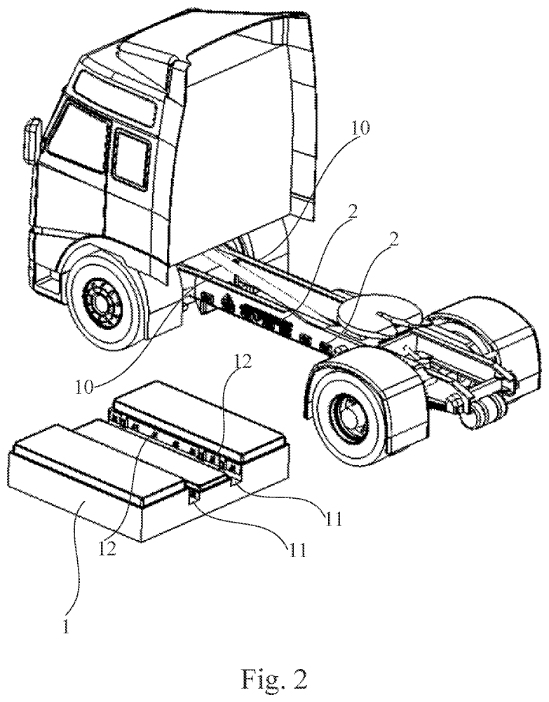

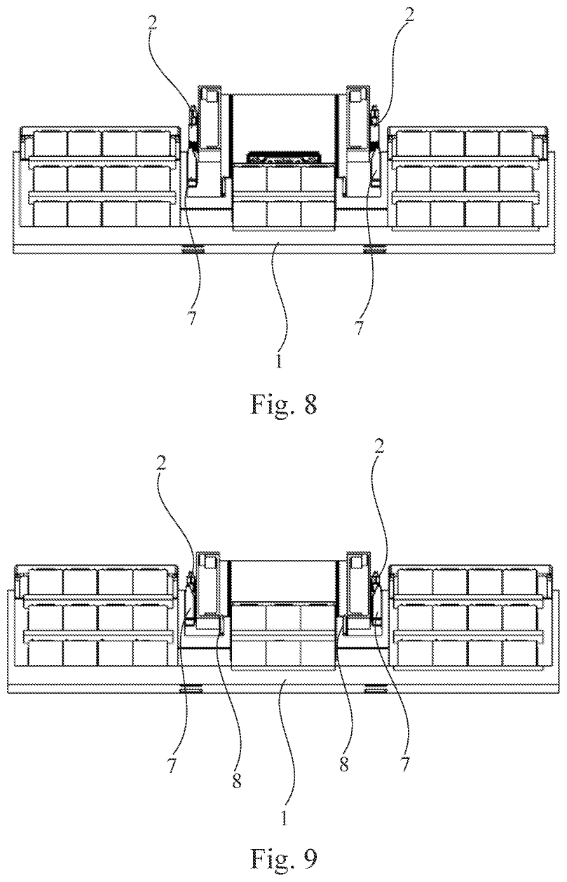

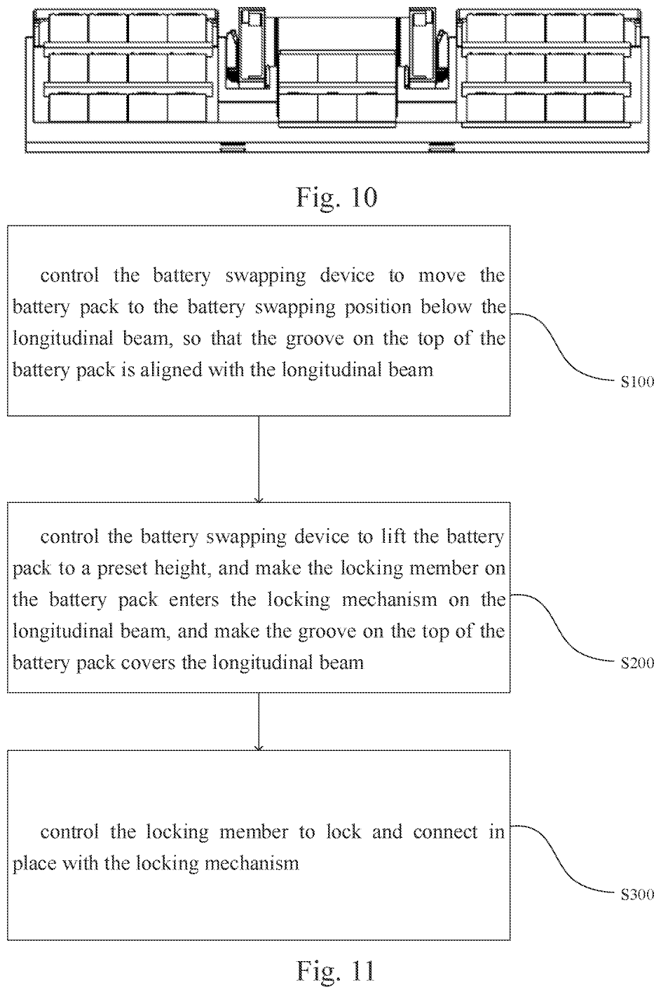

As shown in FIGS. 1 to 10, the embodiment discloses an electric vehicle, which is a commercial vehicle such as a heavy truck or a light truck. The electric vehicle comprises a battery swapping system and two longitudinal beams 10 of an electric vehicle. The battery swapping system of an electric vehicle comprises a battery pack 1 and a plurality of locking mechanisms 2, and the plurality of locking mechanisms 2 are respectively arranged on the two longitudinal beams 10, and the top of the battery pack 1 is provided with a groove 11, and the groove 11 is adopted for embedding the longitudinal beam 10, and the battery pack 1 is provided with a plurality of locking members 12, and the plurality of locking members 12 are located in the groove 11, and the battery pack 1 is locked in a plurality of locking mechanisms 2 by means of a plurality of locking members 12 so as to be connected to the longitudinal beams 10.

By providing the groove 11 on the top of the battery pack 1, the battery pack 1 moves to a battery swapping position below the longitudinal beam 10, and the battery pack 1 moves upwards so that the longitudinal beam 10 is embedded in the groove 11, and the battery pack 1 is connected with the locking structure on the two longitudinal beams 10 by means of the locking member 12 in the groove 11, so that the battery pack 1 is mounted on the two longitudinal beams 10 and the connection between the battery pack 1 and the longitudinal beam 10 is more stable. Conversely, it is achieved that the battery pack 1 is detached from the two longitudinal beams 10. By realizing that swap battery using chassis of the two longitudinal beams 10 of the electric vehicle, and the center of gravity of the battery pack 1 is located below the longitudinal beam 10, the center of gravity of the battery pack 1 can effectively lowered and the stability of the battery pack 1 can be effectively improved, and the stability and safety of the vehicle can be greatly improved; and at the same time, the structure is compact and utilization rate of the space especially the space in the vertical direction is high.

The battery pack 1 comprises a plurality of battery cell accommodating cavities for placing battery cells 3, and at least part of the battery cell accommodating cavities are distributed on the side part of the longitudinal beam 10. The more battery cells 3 are placed in the battery pack 1, the more sufficient the power reserve is, and the farther the electric vehicle travels. At least part of the battery cell accommodating cavities are distributed at the side part of the longitudinal beam 10 so that the battery cells 3 in the battery pack 1 are accommodated and placed along the width direction of the electric vehicle instead of only placing the battery cells 3 along the height direction of the electric vehicle on the longitudinal beam 10, so as to realize that the more battery cells 3 are accommodated in the battery pack 1, the longer the distance of travel is, and the frequency of the battery swapping is reduced; and at the same time, it is realized that the space utilization rate is higher.

A plurality of battery cell accommodating cavities comprise a plurality of side battery cell accommodating cavities 13, and the plurality of side battery cell accommodating cavities 13 are distributed on opposite sides of the two longitudinal beams 10. The battery cells 3 placed in the plurality of the side battery cell accommodating cavities 13 are distributed on the opposite sides of the two longitudinal beams 10 to achieve higher space utilization rate and increase the capacity of the battery cells 3 of the battery pack 1.

A plurality of cross beams are connected between the two longitudinal beams 10, and a plurality of battery cell accommodating cavities further comprises middle battery cell accommodating cavity 14, and a plurality of side battery cell accommodating cavities 13 are distributed on both sides of the middle battery cell accommodating cavity 14 and the middle battery cell accommodating cavity 14 is located below the cross beam and between the two longitudinal beams 10. The overall structural strength is effectively enhanced by means of connecting the plurality of cross beams between the two longitudinal beams 10, and therefore the safety and stability of the electric vehicle are improved. At the same time, the middle battery cell accommodating cavity 14 is used for placing the battery cell 3 therein, so that the space between the two longitudinal beams 10 of the electric vehicle is further fully utilized, and it is realized that the battery cells 3 can be respectively mounted on both sides of the longitudinal beam 10 and between the two longitudinal beams 10, and the utilization rate of the space especially the space in the vertical direction is higher, and the capacity of the battery cell 3 of the battery pack 1 is further increased.

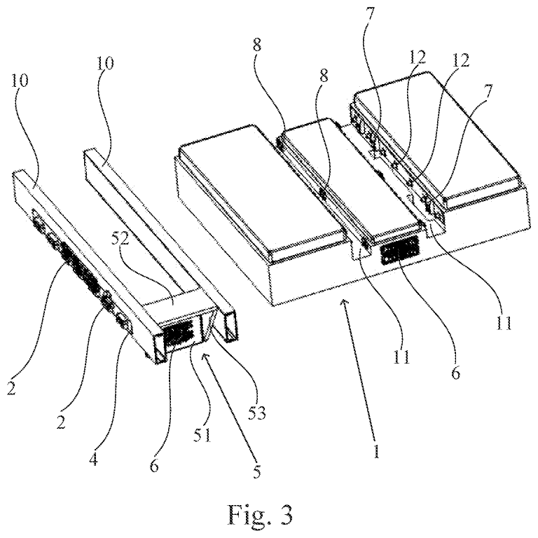

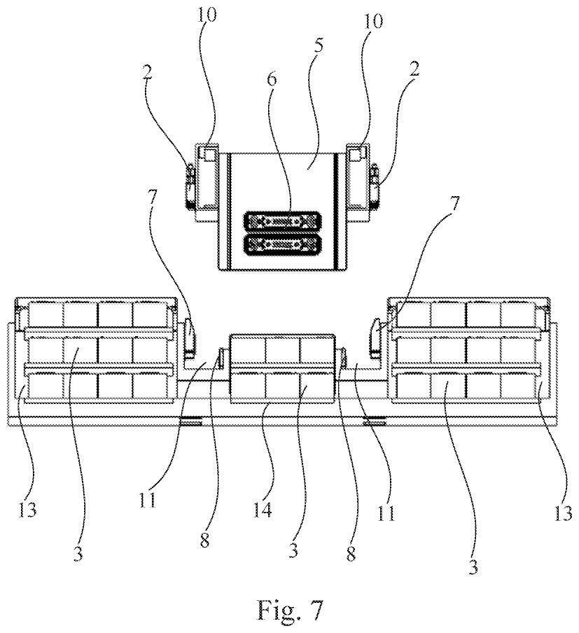

In this embodiment, as shown in FIGS. 3 and 7, the battery pack 1 is provided with two side battery cell accommodating cavities 13 and one middle battery cell accommodating cavity 14, and the height of the middle battery cell accommodating cavity 14 is smaller than the height of the side battery cell accommodating cavity 13, and the two grooves 11 are respectively located between the side battery cell accommodating cavity 13 and the middle battery cell accommodating cavity 14.

In another embodiment, the battery pack 1 is provided with two side battery cell accommodating cavities 13, and a groove is located between the two side battery cell accommodating cavities 13.

In this embodiment, a plurality of locking mechanisms 2 can be respectively arranged on the side walls of the two longitudinal beams 10. Of course, in another embodiment, a plurality of locking mechanisms 2 may also be respectively arranged at the bottom of the two longitudinal beams 10. It realizes a variety of mounting and arranging forms of the locking mechanism 2, and the position can be arranged discretionarily according to the space, and the connection is more stable.

In one embodiment, a plurality of locking mechanisms 2 may be mounted directly on the side surfaces of the two longitudinal beams 10 and/or on the bottom of the longitudinal beams 10.

In another embodiment, the battery swapping system further comprises a fixing bracket, the fixing bracket is arranged on the side walls of the longitudinal beam 10 or at the bottom of the longitudinal beam 10, and a plurality of locking mechanisms 2 are arranged on the fixing bracket. When it is necessary to install a plurality of locking mechanisms 2 on the longitudinal beam 10, it is convenient to mount a plurality of locking mechanisms 2 and the installation accuracy is high through arranging all the plurality of locking mechanisms 2 on the fixing bracket and forming a whole first, and then mounting the fixing bracket as a whole on the longitudinal beam 10; and at the same time, the strength and stability of the battery swapping system are improved.

The fixing bracket comprises two mounting beams 4, one side of the two mounting beams 4 is respectively connected to opposite sides of the two longitudinal beams 10, and a plurality of locking mechanisms 2 are respectively connected to the other side of the two mounting beams 4. A plurality of locking mechanisms 2 are mounted on two mounting beams 4, and then the two mounting beams 4 are respectively mounted on the opposite surfaces of the two longitudinal beams 10, so as to realize the mounting of the plurality of locking mechanisms 2, therefore the installation accuracy is high; and at the same time, the strength and stability of the battery swapping system are improved.

The locking mechanism 2 comprises a locking groove for the locking member 12 to insert into, the opening of the locking groove facing the outer side of the longitudinal beam. When locking, the groove 11 covers the longitudinal beam 10, and the locking member 12 in the groove 11 inserts into the locking groove through the opening of the locking groove, so that the locking of the locking member 12 and locking mechanism 2 is realized. When unlocking, the locking member 12 is moved out of the locking groove so that the battery pack 1 and the two longitudinal beams 10 can be separated from each other, and therefore the unlocking of the locking member 12 and the locking mechanism 2 is realized. It is achieved that the locking member 12 can be conveniently inserted into the locking groove and the structure of the locking groove is simple and convenient for machining and manufacturing.

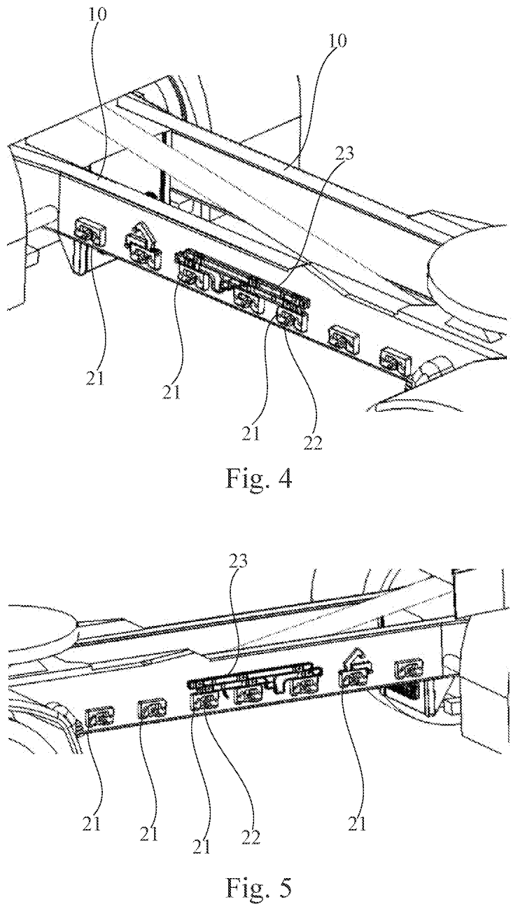

In this embodiment, as shown in FIGS. 4 and 5, the locking mechanism 2 comprises a locking base 21, and a plurality of locking bases 21 are respectively arranged on two opposite side walls of the two longitudinal beams 10, and as shown in FIG. 3, a plurality of locking members 12 are respectively arranged on the inner wall surface of the groove 11, and the locking members 12 are arranged opposite to the corresponding locking bases 21.

In another embodiment, the plurality of locking bases 21 are respectively arranged at the bottom of the two longitudinal beams 10, and the plurality of locking members 12 are arranged at the bottom of the groove 11.

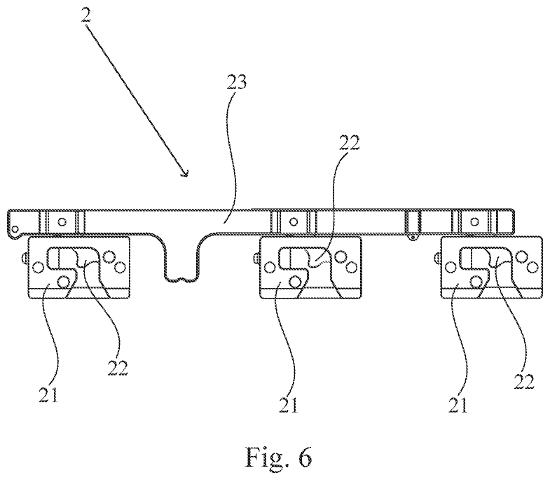

As shown in FIG. 6, the locking base 21 is provided with an opening groove extending in the vertical direction and a locking groove extending in the horizontal direction, the locking member 12 is a locking shaft, and the locking groove is used for the locking member 12 to insert into and be locked, and the top of the opening groove is communicated with the locking groove, and the locking member 12 enters the locking groove when reaching the junction position of the opening groove and the locking groove from the bottom of the opening groove in the vertical direction.

At least part of the locking bases 21 are provided with a locking tongue 22, and the locking tongue 22 is movably mounted in the locking groove and can prevent the locking member 12 from getting out of the locking groove. The locking tongue 22 extends into the locking groove, and thereby it is possible to prevent the locking member 12 from getting out of the locking groove, and it is realized that the locking member 12 is stably inserted into the locking groove, and the locking is more reliable, and thereby the stability of the locking mechanism 2 in the locking state is improved.

The locking mechanism 2 further comprises a locking linkage 23, the locking linkage 23 is movably connected to the locking base 21 by means of the locking tongue 22. The lock linkage 23 drives the locking tongue 22 to close or open the locking groove under external force, and the locking is more reliable; and at the same time, the synchronous unlocking or locking of the plurality of locking tongues 22 can be realized through the locking linkage 23, which is very convenient to use and reduces the cost.

When locking, the locking member 12 moves upwards in the vertical direction, and reaches the junction position of the opening groove and the locking groove from the bottom of the opening groove, and then the locking member 12 enters the groove in the horizontal direction, so that the locking member 12 is inserted into and locked in the locking groove so that the locking of the locking member 12 and the locking mechanism 2 is realized. When unlocking, the locking member 12 will move in the horizontal direction to the junction position of the opening groove and the locking groove, and then the locking member 12 moves downwards in the vertical direction, so that the locking member 12 gets out of the locking base 21 from the bottom of the opening groove so that the unlocking of the locking member 12 and the locking mechanism 2 is realized. The battery pack 1 can be locked or unlocked through the displacement in the vertical and horizontal directions, which is very convenient to mount and detach, and the structure is simple and convenient for machining and manufacturing.

In another embodiment, the locking base 21 is provided with a first opening extending along the vertical direction, the first opening is provided with a first thread part or a limiting part, and the locking member 12 is provided with a matched second thread part or a backstopping part, the locking base 21 and the locking member 12 are vertically locked up and down. With the above-mentioned locking structure, the locking between the locking base 21 and the locking member 12 can be realized only in the vertical direction, and it realizes a variety of mounting and arranging forms, the connection is more stable, and the utilization rate of the structural space is high.

Of course, in another embodiment, the locking base 21 and the locking member 12 are connected with each other through any one of screw connection, clip connection, buckle connection, plug connection, hook connection and tenon connection to realize the mounting and connection of the battery pack on the longitudinal beam 10.

As shown in FIG. 3, the battery swapping system also comprises a reinforcement member 5 for mounting the electrical connector 6, the reinforcement member 5 being located between the two longitudinal beams 10, and the two ends of the reinforcement member 5 are respectively connected to the two longitudinal beams 10. The reinforcement member 5 performs a function of strengthening, and by means of the reinforcement member 5 connected with the two longitudinal beams 10, the overall structural strength of the electric vehicle is effectively enhanced and the safety and stability of the electric vehicle are improved.

The reinforcement member 5 comprises a connecting member 52 and a mounting plate 51, the connecting member 52 is respectively connected to the two longitudinal beams 10 and the mounting plate 51, and the mounting plate 51 is used for mounting the electrical connector 6. By means of the connecting member 52 connected with the two longitudinal beams 10, the connection strength of the structure is enhanced. The electrical connector 6 is mounted on the mounting plate 51, and the mounting of the electrical connector 6 is convenient through the mounting plate 51.

The reinforcement member 5 further comprises two reinforcing plates 53, and the two reinforcing plates 53 are respectively connected to the two longitudinal beams 10, and the reinforcement plates 53 are connected to the connecting member 52 and the mounting plate 51. The two reinforcement plates 53 performs a reinforcing function, which effectively enhances the structural connection strength and improves the safety and stability of the electric vehicle. Wherein, an accommodating space is formed between the mounting plate 51, the connecting member 52 and the two reinforcement plates 53, and the electrical connector 6 will be arranged in the accommodating space. The reinforcement member 5 will perform a function of shielding and protecting to the electrical connector 6, and the safety and stability are improved.

The electrical connector 6 comprises a detachable electrically connected vehicle-side electrical connector and a battery-side electrical connector, and the vehicle-side electrical connector is arranged on the mounting plate 51 and the battery-side electrical connector is arranged on the battery pack 1. Wherein, the number of the vehicle-side electrical connectors and the battery-side electrical connectors are both two, and the vehicle-side electrical connectors and the battery-side electrical connectors are both arranged at intervals from top to bottom. The vehicle-side electrical connectors and the battery-side electrical connectors adopt two standard connectors, and the safety and load-bearing capacity are improved, and at the same time, it is relatively economical and costs less as a standard members.

The battery swapping system also comprises a plurality of guiding and positioning mechanisms, and the plurality of guiding and positioning mechanisms are arranged on the longitudinal beam 10 or the battery pack 1 so as to realize the precise positioning of the battery pack 1 on the longitudinal beam 10. The guiding and positioning mechanism performs a guiding and positioning function, so that the battery pack 1 can be positioned right by the guiding and positioning acting force of the guiding and positioning mechanism, thereby realizing precise positioning, and the installation and disassembly of the battery pack 1 are more stable.

In this embodiment, as shown in FIG. 3, the plurality of guiding and positioning mechanisms comprise a plurality of initial positioning mechanisms 7, and the plurality of initial positioning mechanisms 7 are respectively arranged at intervals on the inner wall surface of the battery pack 1, the plurality of initial positioning mechanisms 7 and the locking member 12 being located on the same side, and the plurality of initial positioning mechanisms 7 match the longitudinal beam 10 or the locking mechanism 2 on the longitudinal beam 10 to carry out initial positioning and guiding of the battery pack 1.

The plurality of guiding and positioning mechanisms comprise a plurality of precise positioning mechanisms 8, and the plurality of precise positioning mechanisms 8 are respectively arranged at intervals on the inner surface of the battery pack 1, the precise positioning mechanism 8 and the initial positioning mechanism 7 are arranged opposite to each other, and the plurality of precise positioning mechanisms 8 cooperate with the longitudinal beam 10 to carry out precise positioning and guiding for the battery pack 1.

The guiding and positioning mechanism is an elastic positioning mechanism. The elastic positioning mechanism comprises a mounting casing, a positioning part and an elastic component, and the mounting casing is fixed to the battery pack 1, and an accommodating cavity is provided inside the mounting casing, and the outer side surface of the mounting casing is provided with a mounting opening communicated with the accommodating cavity, and the positioning part penetrates through the mounting opening, and the outer side surface of the positioning part extends out of the mounting opening and abuts against the side surface of the longitudinal beam 10, and the elastic component acts on the inner side surface of the positioning part and transmits a changing force between the positioning part and the mounting casing to provide outward clamping force to the longitudinal beam 10. Wherein, the top of the outer side surface of the mounting casing is provided with a first sliding guide surface. The top of the positioning part which extends out of the mounting opening is provided with a second sliding guide surface.

As shown in FIG. 11, the embodiment also discloses a battery swapping method of an electric vehicle, which adopts the above-mentioned battery swapping system for an electric vehicle. The battery swapping method comprises the following steps:

Step S100: the battery swapping device is controlled to move the battery pack 1 to the battery swapping position below the longitudinal beam 10, so that the groove 11 on the top of the battery pack 1 is aligned with the longitudinal beam 10.

Step S200: the battery swapping device is controlled to lift the battery pack 1 to a preset height, so that the locking member 12 on the battery pack 1 enters the locking mechanism 2 on the longitudinal beam 10, and the groove 11 on the top of the battery pack 1 covers the longitudinal beam 10.

Step S300: the locking member 12 is controlled to be locked and connected in place with the locking mechanism 2.

The battery pack 1 is added to the bottom of the electric vehicle from the side of the electric vehicle, and the battery pack 1 is driven by the displacement of battery swapping device to the battery swapping position below the electric vehicle, so that the groove 11 on the top of the battery pack 1 is aligned with the longitudinal beam 10, thus realize precise control, high safety and stability. After the battery pack 1 approaches to the longitudinal beam 10, the battery swapping device lifts the battery pack 1 upward in the vertical direction, it is realized that the battery pack 1 is lifted to a preset height, so that the locking member 12 moves through the opening groove to the junction position of the opening groove and the locking groove; and finally, the locking member 12 is controlled to enter the locking groove to realize locking in place with the locking mechanism 2. It is realized to swap battery using the chassis of the two longitudinal beams 10 of the electric vehicle, and the failure risk in battery swapping is reduced, and the safety is improved, and the floor area of the chassis battery swapping system is small, and the popularization cost of the battery swapping station is low.

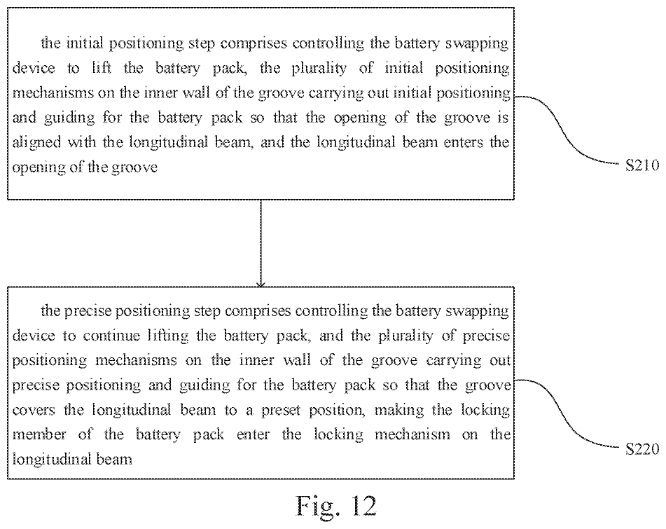

As shown in FIG. 12, the step of controlling the battery swapping device to lift the battery pack 1 to a preset height also comprises an initial positioning step:

Step 210: the initial positioning step comprises controlling the battery swapping device to lift a battery pack, the plurality of initial positioning mechanisms 7 on inner wall of the groove 11 carry out initial positioning guidance for the battery pack 1, so that the opening of the groove 11 is aligned with the longitudinal beam 10, and the longitudinal beam 10 enters the opening of the groove 11.

Through the plurality of initial positioning mechanisms 7 match the longitudinal beam 10 or the locking mechanism 2 on the longitudinal beam 10, carry out initial positioning and guiding for the battery pack 1, so that the longitudinal beam 10 is precisely aligned with the groove 11 and smoothly enters the groove 11, and the safety and stability are improved

The step of controlling the battery swapping device to lift the battery pack 1 to a preset height further comprises a precise positioning step, and the precise positioning step is after the initial positioning step:

Step S220: the precise positioning step comprises controlling the battery swapping device to continue lifting the battery pack 1, and carrying out precise positioning and guiding for the battery pack 1 by the plurality of precise positioning mechanisms 8 on the inner wall surface of groove 11, so that the groove 11 covers the longitudinal beam 10 to a preset position, so that the locking member 12 on the battery pack 1 enters the locking mechanism 2 on the longitudinal beam 10.

After the initial positioning step of the battery pack 1, the longitudinal beam 10 enters the groove 11, and the precise positioning step starts, and the plurality of precise positioning mechanisms 8 match the longitudinal beam 10 to carry out precise positioning and guiding for the battery pack 1, thus locking of the battery pack 1 has higher accuracy; and at the same time, it effectively prevents the battery pack 1 from producing deviation and dislocation during use, and greatly improves the safety and stability.

In this embodiment, the plurality of initial positioning mechanisms 7 and the plurality of precise positioning mechanisms 8 both abut against the longitudinal beam 10 and limit displacement of the longitudinal beam 10 in the groove 11. The plurality of initial positioning mechanisms 7 and a plurality of precise positioning mechanisms 8 respectively abut against both sides of the longitudinal beam 10, and the inclined displacement of the longitudinal beam in the horizontal direction is therefore effectively limited, and the safety and stability are improved.

By adopting the technical solution in the embodiment, the height space below the longitudinal beam is fully utilized, and when the battery swapping device disassembles the battery pack, the unloaded battery swapping device can directly enter the space below the battery pack without interfering with the bottom of the electric vehicle; and when the battery swapping device mounts the battery, the battery swapping device loaded with the battery pack can directly enter the underside of the longitudinal beam without interference with the bottom of the electric vehicle. In the whole process, there is no necessity to lift the vehicle body, or set up a sunken space or dig a hole for the battery swapping device to enter and exit, and the cost, time and difficulty of building a battery swapping station are reduced, and the requirement of the site to built a station is reduced, and the efficiency of battery swapping is improved.

While the specific implementation of the invention has been described above, it should be understood by a person skilled in the art that this is illustrative only, and that the scope of protection of the invention is defined by the appended claims. A person skilled in the art may make various alterations or modifications to these implementations without departing from the principles and essence of the present invention, but these alterations or modifications fall within the scope of protection of the invention.

1. A swapping system for an electric vehicle, the electric vehicle comprises two longitudinal beams, wherein the electric vehicle comprises a battery pack and a plurality of locking mechanisms, and the plurality of locking mechanisms are respectively arranged on the two longitudinal beams, and the top of the battery pack is provided with a groove, and the groove is used for embedding the longitudinal beams, and the battery pack is provided with a plurality of locking members, and the plurality of locking members are located in the groove, and the battery pack is locked in the plurality of locking mechanisms by means of the plurality of locking members so as to be connected with the longitudinal beams.

2. The battery swapping system for the electric vehicle according to claim 1, wherein the plurality of locking mechanisms are respectively arranged on the side walls of the two longitudinal beams and/or the bottom of the longitudinal beams.

3. The battery swapping system for the electric vehicle as claimed in claim 1, wherein the battery pack comprises a plurality of battery cell accommodating cavities for placing battery cells, and at least part of the battery cell accommodating cavities are distributed on the side part of the longitudinal beam.

4. The battery swapping system for the electric vehicle according to claim 3, wherein the plurality of battery cell accommodating cavities comprise a plurality of side battery cell accommodating cavities, and the plurality of side battery cell accommodating cavities are distributed on two opposite sides of the two longitudinal beams;
preferably, a plurality of cross beams are connected between the two longitudinal beams, and the plurality of battery cell accommodating cavities further comprise a middle battery cell accommodating cavity, the plurality of side battery cell accommodating cavities being distributed on both sides of the middle battery cell accommodating cavity, and the middle battery cell accommodating cavity is located below the cross beams.

5. The battery swapping system for the electric vehicle according to claim 1, wherein the battery swapping system further comprises a fixing bracket, the fixing bracket being arranged on the side walls of the longitudinal beam or at the bottom of the longitudinal beam, and the plurality of locking mechanisms are arranged on the fixing bracket;
preferably, the fixing bracket comprises two mounting beams, one side of the two mounting beams being respectively connected to the opposite sides of the two longitudinal beams, and the plurality of locking mechanisms are respectively connected to the other side of the two mounting beams.

6. The battery swapping system for the electric vehicle according to claim 1, wherein the battery swapping system further comprises a reinforcement member for mounting the electrical connector, the reinforcement member being located between the two longitudinal beams and the two ends of the reinforcement member are respectively connected to the two longitudinal beams.

7. The battery swapping system for the electric vehicle according to claim 6, wherein the reinforcement member comprises a connecting member and a mounting plate, the connecting member is respectively connected to the two longitudinal beams and the mounting plate, and the mounting plate is used for mounting the electrical connector;
preferably, the reinforcement member further comprises two reinforcement plates, the two reinforcement plates being respectively connected to the two longitudinal beams, and the reinforcement plates are connected to the connecting member and the mounting plate.

8. The battery swapping system for the electric vehicle according to claim 1, wherein the locking mechanism comprises a locking groove for the locking member to insert into, the opening of the locking groove faces the outer side of the longitudinal beam.

9. The battery swapping system for the electric vehicle according to claim 1, wherein the locking mechanism comprises a locking base, the locking base being provided with an opening groove extending in the vertical direction and a locking groove extending in the horizontal direction, the locking member being a locking shaft, and the locking groove is used for the locking shaft to insert into and be locked, and the top of the opening groove is communicated with the locking groove, and when the locking shaft reaches the junction position of the opening groove and the locking groove from the bottom of the opening groove in the vertical direction, the locking shaft enters the locking groove.

10. The battery swapping system for the electric vehicle according to claim 9, wherein at least part of the locking bases are provided with a locking tongue, and the locking tongue is movably mounted in the locking groove and can prevent the locking shaft from getting out of the locking groove.

11. The battery swapping system for the electric vehicle according to claim 10, wherein the locking mechanism further comprises a locking linkage, the locking linkage being movably connected with the locking base by means of the locking tongue.

12. The battery swapping system for the electric vehicle according to claim 1, wherein the locking mechanism comprises a locking base, the locking base being provided with an opening extending along the vertical direction, and the opening is provided with a first thread part or a limiting part, and the locking member is provided with a matched second thread part or stopping part.

13. The battery swapping system for the electric vehicle according to claim 1, wherein the battery swapping system further comprises a plurality of guiding and positioning mechanisms, and the plurality of guiding and positioning mechanisms are arranged on the longitudinal beam or the battery pack so as to realize the precise positioning of the battery pack on the longitudinal beam;
preferably, the guiding and positioning mechanism is an elastic positioning mechanism.

14. An electric vehicle, wherein the electric vehicle is a heavy truck or a light truck, and the electric vehicle comprises the battery swapping system for an electric vehicle according to claim 1.

15. A battery swapping method for an electric vehicle, which adopts the battery swapping system for an electric vehicle according to claim 1, wherein the battery swapping method comprises the following steps:
control the battery swapping device to move the battery pack to the battery swapping position below the longitudinal beam, so that the groove on the top of the battery pack is aligned with the longitudinal beam;
control the battery swapping device to lift the battery pack to a preset height, and make the locking member on the battery pack enters the locking mechanism on the longitudinal beam, and make the groove on the top of the battery pack covers the longitudinal beam;
control the locking member to lock and connect in place with the locking mechanism.

16. The battery swapping method for the electric vehicle according to claim 15, wherein the step of controlling the battery swapping device to lift the battery pack to a preset height further comprises an initial positioning step;
the initial positioning step comprises controlling the battery swapping device to lift the battery pack, the plurality of initial positioning mechanisms on the inner wall of the groove carrying out initial positioning and guiding for the battery pack so that the opening of the groove is aligned with the longitudinal beam, and the longitudinal beam enters the opening of the groove.

17. The battery swapping method for the electric vehicle according to claim 16, wherein the step of controlling the battery swapping device to lift the battery pack to a preset height further comprises a precise positioning step, and the precise positioning step is after the initial positioning step;
the precise positioning step comprises controlling the battery swapping device to continue lifting the battery pack, and the plurality of precise positioning mechanisms on the inner wall of the groove carrying out precise positioning and guiding for the battery pack so that the groove covers the longitudinal beam to a preset position, making the locking member of the battery pack enter the locking mechanism on the longitudinal beam.

18. The battery swapping method for the electric vehicle according to claim 17, wherein the plurality of initial positioning mechanisms and the plurality of precise positioning mechanisms abut against the longitudinal beam and limit the displacement of the longitudinal beam in the groove.
